(19) United States
(12) Patent Application Publication
(10) Pub. No.: US 2022/0374266 A1
(43) Pub. Date: Nov. 24, 2022

(54) ELECTRONIC SYSTEM FOR DYNAMIC EVENT-BASED INTEGRATION OF RESOURCES AND TEMPORAL RESOURCE PROCESSING

(71) Applicant: BANK OF AMERICA CORPORATION, Charlotte, NC (US)

(72) Inventors: Kashif M. Siddiqui, Livingston, NJ (US); Ryan Elizabeth Barlow, New York, NY (US); Richard C. Clow, II, Morristown, NJ (US); Justin duPont, Huntersville, NC (US); Emily Elizabeth Pansa, Charlotte, NC (US); Kristin Hodge Wallace, Charlotte, NC (US)

(73) Assignee: BANK OF AMERICA CORPORATION, Charlotte, NC (US)

(21) Appl. No.: 17/329,052

(22) Filed: May 24, 2021

(51) Int. Cl. G06F 9/50; G06F 9/54

(52) U.S. Cl. CPC G06F 9/5005; G06F 9/547

(57) ABSTRACT

Embodiments of the invention are directed to systems, methods, and computer program products for dynamic event-based integration of resources and temporal resource processing. The invention is structured for dynamic integration of resources and resource processing based on events. Embodiments of invention may be configured for determining technology activity systems associated with a user, analyzing resources data on a user's device, determining temporal action triggers, transmitting temporal action triggers, modifying user activity programs, and conducting modified user activity programs. The invention may also be configured for determining a user's geographical location, and predict the effect of geographical location and other parameters on the resource level of the user.

### FIELD OF THE INVENTION

The present invention embraces a computerized system for dynamic event-based integration of resources and temporal resource processing and identifying resources and predicting the effect of temporal action triggers on the magnitude of resources associated with a user. The system is typically configured for determining technology activity systems associated with a user, analyzing user resource data, determining a temporal action trigger, transmitting temporal action trigger, modifying user activity program, and conducting the modified user activity program.

### BACKGROUND

With the proliferation of network technology in recent times, network devices and associated users are typically in operative communication with numerous disparate technology activity systems. Typically, the users may perform actions relating to resource transmissions and modifications associated with the various technology activity systems. However, conventional systems are unable to identify the disparate actions associated with the technology activity systems, much less analyze the specific parameters, and operatively connect and map interrelated actions. Moreover, the inherent disparate, temporal, and dynamically variable nature of the user actions and associated resource transmissions and modifications associated with the various technology activity systems, causes inefficiencies of computing resources such as processing power, memory, and network bandwidth in conventional systems.

Accordingly, there is a need for novel systems that alleviate the foregoing drawbacks of conventional systems.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

The novel invention described herein relates to systems, methods and computer program products for dynamic event-based integration of resources and temporal resource processing, which provides solutions to the foregoing problems conventional systems and also provides other advantages. The present invention is further structured for dynamic integration of resources and resource processing based on events. In a first aspect includes a system for dynamic event-based integration of resources and temporal resource processing where the system is structured for dynamic integration of resources and resource processing based on events. The system includes at least one memory device with computer-readable program code stored thereon. The system includes at least one communication device. The system includes at least one processing device operatively coupled to the at least one memory device and the at least one communication device. Typically, executing the computer-readable program code is configured to cause the at least one processing device to perform one or more steps performed by the system described herein. In accordance with some embodiments of the invention, the system, via the at least one processing device, establishes an operative communication channel with a user device associated with a user; and determines, via the operative communication channel with the user device, one or more technology activity systems associated with the user, where the user is associated with one or more user activities with each of the one or more technology activity systems. The system then extracts user resource data associated with one or more resources of the user, wherein each of the one or more resources are connected to at least one of the one or more technology activity systems such that the one or more user activities associated with the one or more technology activity systems activates a modification to a resource level of at least one of the one or more resources. Next, the system analyzes user activity data associated with the one or more technology systems to construct a user activity program associated with the user, wherein constructing the user activity program may include one or more user program actions of the one or more user activities, and wherein each of the one or more user program actions is associated with one or more action attributes. The system further determines, via the one or more technology systems, a temporal action trigger associated with the user activity program, wherein the temporal action trigger is associated with (i) a time attribute, (ii) a geographical local attribute, and (iii) an event attribute that matches the user activity program, wherein the temporal action trigger is structured to cause an escalation of a resource level of at least one of the one or more resources. Next, the system transmits, via the operative communication channel, the temporal action trigger to the user device, and further modifies, in real time, the user activity program based on the temporal action trigger in response to receiving a predetermined input from the user at the user device. Finally, the system conducts, via the user device, the modified user activity program.

In some embodiments, or in combination in any of the previous embodiments, the invention is further configured to analyze one or more applications on the user device, and determine the one of more technology activity systems based on analyzing the one or more applications.

In some embodiments, or in combination in any of the previous embodiments, determining the temporal action trigger associated with the user activity program further comprises: extracting geographic location data from the user device; and constructing the time attribute and the geographical local attribute associated with the temporal action trigger based on at least the geographic location data associated with the user device.

In some embodiments, or in combination in any of the previous embodiments, determining the temporal action trigger associated with the user activity program further comprises: determining a user geographic region associated with the user based on analyzing geographic location data associated with the user; determining one or more events that match the user geographic region, wherein the user activity program is not associated with the one or more events; identifying a first event of the one or more events such that (i) the first event matches the user activity program and (ii) modifying the user activity program to include the first event is structured to cause the escalation of the resource level of the at least one of the one or more resources; and constructing the event attribute associated with the temporal action trigger based on the first event.

In some embodiments, or in combination in any of the previous embodiments, the invention is further configured to: analyze user resource data associated with the one or more resources of the user; determine, for each of the one or more resources, the one or more technology activity systems that are associated with modifications to the associated resource level; aggregate the user activity data and the user resource data across the one or more technology activity systems, comprising determining, in real-time, for each of the one or more technology activity systems, incoming resource transfers, outgoing resource transfers, and net escalation of the resource level for the one or more user activities; and initiate, via the operative communication channel with the user device, a presentation of an integrated interface comprising the aggregated user activity data and user resource data in real-time on a display device of the user device.

In some embodiments, or in combination in any of the previous embodiments, the invention is further configured to: receive, via the operative communication channel with the user device, a first program action of the one or more program actions from the user; based on the aggregated user activity data and user resource data, determine a first net escalation of the resource level for the first program action; and initiate, via the operative communication channel with the user device, a presentation of the first net escalation of the resource level on the display device of the user device.

In some embodiments, or in combination in any of the previous embodiments, the temporal action trigger is structured to modify the first program action. Here, the invention is further configured to determine the temporal action trigger associated with the user activity program such that the temporal action trigger causes the escalation of the resource level of at least one of the one or more resources by (i) causing a second net escalation of the resource level that is greater than the first net escalation, or (ii) converting a negative first net escalation of the resource level to a positive net escalation of the resource level for the first program action.

In some embodiments, or in combination in any of the previous embodiments, the temporal action trigger is structured to modify a time associated with at least one of the incoming resource transfers and the outgoing resource transfers.

In some embodiments, or in combination in any of the previous embodiments, transmitting the temporal action trigger to the user device further comprises: initiating, via a display device of the user device, a presentation of the temporal action trigger on via an integrated interface of a user device application, wherein the presentation of the temporal action trigger comprises the escalation of the resource level of the at least one of the one or more resources and prior resource level in absence of the temporal action trigger; and receiving the predetermined input from the user via the integrated interface of the user device application.

In some embodiments, or in combination in any of the previous embodiments, the one or more technology activity systems associated with the user are determined based on analyzing one or more applications on the user device.

In some embodiments, or in combination in any of the previous embodiments, the system may further extract geographic location data from the user device.

In some embodiments, or in combination in any of the previous embodiments, the system may further aggregate user resource data across platforms.

In some embodiments, or in combination in any of the previous embodiments, the system may further implement the one or more temporal action triggers in real-time with a predetermined time-interval.

Some embodiments may include one or more of the following features. The computer program product where the one or more technology activity systems associated with the user is determined based on analyzing one or more applications on the user device. Executing the computer-readable program code is further configured to cause the at least one processing device to extract geographic location data from the user device. Executing the computer-readable program code is further configured to cause the at least one processing device to aggregate user resource data across platforms. Executing the computer-readable program code is further configured to cause the at least one processing device to present the one or more temporal action triggers to the user via an application with an integrated interface for viewing and manipulating integrated resource data on the user device. Executing the computer-readable program code is further configured to cause the at least one processing device to implement the one or more temporal action triggers in real-time with a predetermined time-interval.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 depicts an operating network environment structured for dynamic event-based integration of resources and temporal resource processing, in accordance with one embodiment of the present invention;

FIG. 2 illustrates a schematic depiction of a resource processing system of FIG. 1, in accordance with one embodiment of the present invention;

FIG. 3 illustrates a schematic depiction of a user device of FIG. 1, in accordance with one embodiment of the present invention; and

FIG. 4 depicts a high level process flow for dynamic event-based integration of resources and temporal resource processing, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

“Entity” as used herein may refer to an individual or an organization that owns and/or operates the resource processing systems and the associated computing systems. The entity may be a business organization, a non-profit organization, a government organization, a financial institution, and/or the like.

“User” as used herein may refer to an individual associated with an entity. As such, in some embodiments, the user may be an individual having past relationships, current relationships or potential future relationships with an entity. In some embodiments, the user may be a representative of a business entity. Typically, the user is authorized and/or authenticated by one or more entities of the system. Accordingly, the user may be a customer or prospective customer of an entity. Alternatively, the user may be an employee of an entity.

“User device” as used herein may refer to a computing device used by the user to access the system through an online portal. The user device may include a processor, a non-transitory storage medium, a communications device, and a display. The system may support user logins and inputs from any combination of disparate devices. Accordingly, the user device may be a portable electronic device such as a smartphone, tablet, or laptop, or the user device may be a stationary unit such as a personal desktop computer or a networked terminal within an entity's premises.

In the instances where the entity is a resource entity or a merchant, financial institution and the like, a user may be an individual or entity with one or more relationships, affiliations or accounts with the entity (for example, the merchant, the financial institution). A “technology resource”, “resource”, or “account” as used herein may be the relationship that the user has with the entity. Examples of technology resources include a deposit account, such as a transactional account (e.g. a banking account), a savings account, an investment account, a money market account, a time deposit, a demand deposit, a pre-paid account, a credit account, information associated with the user, or the like. The technology resource or account is typically associated with and/or maintained by an entity, and is typically associated with technology infrastructure such that the resource or account may be accessed, modified or acted upon by the user electronically, for example using or transaction terminals, user devices, merchant systems, and the like. In some embodiments, the entity may provide one or more technology instruments or financial instruments to the user for executing resource transfer activities or financial transactions. In some embodiments, the technology instruments/financial instruments like electronic tokens, credit cards, debit cards, checks, loyalty cards, entity user device applications, account identifiers, routing numbers, passcodes and the like are associated with one or more resources or accounts of the user. In some embodiments, an entity may be any institution, group, association, club, establishment, company, union, authority or the like with which a user may have a relationship. As discussed, in some embodiments, the entity represents a vendor or a merchant with whom the user engages in financial (for example, resource transfers like purchases, payments, returns, enrolling in merchant accounts and the like) or non-financial transactions (for resource transfers associated with loyalty programs and the like), either online or in physical stores.

An electronic activity, also referred to as a “technology activity” or a “user activity”, “user program action”, may refer to any action by the user that results in a change to the user's resource level. The user activity may result in an increase in resource level, the user activity may result in a decrease in resource level. The electronic activities, technology activities, user activities, or user program actions may be associated with one or more “technology activity systems,” wherein the technology activity system is associated with a user device. As an example, a ride-sharing activity or action may be associated with an application or technology activity system, on a user device. As another example, a delivery activity may be associated with an application or technology activity system, on a user device. Another example, a short-term vehicle or home rental activity may be associated with an application or technology activity system, on a user device. A user may be associated with one or more technology activity systems and one or more user activities.

“Resource transfer” or “transaction”, may refer to any activities or communication between a user or entity and the financial institution, between the user and the entity, activities or communication between multiple entities, communication between technology applications and the like. A resource transfer may refer to a payment, processing of funds, purchase of goods or services, a return of goods or services, a payment transaction, a credit transaction, or other interactions involving a user's resource or account. In the context of a financial institution or a resource entity such as a merchant, a resource transfer may refer to one or more of: transfer of resources/funds between financial accounts (also referred to as “resources”), deposit of resources/funds into a financial account or resource (for example, depositing a check), withdrawal of resources or finds from a financial account, a sale of goods and/or services, initiating an automated teller machine (ATM) or online banking session, an account balance inquiry, a rewards transfer, opening a bank application on a user's computer or mobile device, a user accessing their e-wallet, applying one or more coupons to purchases, or any other interaction involving the user and/or the user's device that invokes or that is detectable by or associated with the financial institution. A resource transfer may also include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like. Unless specifically limited by the context, a “resource transfer,” a “transaction,” a “transaction event,” or a “point of transaction event,” refers to any user activity (financial or non-financial activity) initiated between a user and a resource entity (such as a merchant), between the user and the financial instruction, or any combination thereof. In some embodiments, a resource transfer or transaction may refer to financial transactions involving direct or indirect movement of funds through traditional paper transaction processing systems (i.e. paper check processing) or through electronic transaction processing systems. In this regard, resource transfers or transactions may refer to the user initiating a funds/resource transfer between account, funds/resource transfer as a payment for the purchase for a product, service, or the like from a merchant, and the like. Typical financial transactions or resource transfers include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated it could mean that the transaction has already occurred, is in the process of occurring or being processed, or it has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures, and the like.

“Resource data” as used herein may refer to a data structure that is associated with a particular resource. Resource data is identified, manipulated, or classified by the system, and may include various types of information upon which the system performs its various functions. In some embodiments, the information may include an offer to sell goods or services. In some embodiments, the information may include resource parameters, authorized action, resource limit thresholds, and/or the like. In some embodiments, the resource data may include historical activities/actions associated with the resource, incoming resource transfers, outgoing resource transfers, and/or the like. The information may further include location data, pricing data, or time data. The information may further include information associated with a user or various activities/actions (e.g., historical actions) associated with the user.

“Classification” as used herein refers to a status attributed to resource data by the system in order to provide for organization or grouping of the resources. In some embodiments, resources may be classified by “likeness,” or by certain similar characteristics inherent to the resource. In some embodiments, resources may also be classified according to links established by the system's user base, independently of the “likeness” of the resources within such a classification. In this way, the system may intelligently provide recommendations of resources to the user even if the relevance of such resources to the user is not immediately evident. Classifications for resources may be stored in a classifications database, and may include a unique fixed-length string to identify the classification. The fixed-length string may be a numerical value such as “8251,” a cryptographic hash, or a plain-text description of the classification, such as “Linux drivers.”

“User activity program” may refer to one or more user program actions predicted to cause an increase in resource level. The user activity program may have a time attribute, a geographical location attribute, and/or an event attribute.

Embodiments of the present invention provide a system for identifying and determining temporal action triggers associated with a user activity program to optimize resource levels and determine resource outlook. Temporal action triggers include time, geographical location and/or event information. For example, the system may use machine learning to predict the impact of temporal action triggers on the resource level of a user. The system may identify, via user upload or user permission to access, variables such as geographical location, skillset, application data, resource data, and resource transfer data.

The system may include a data collection module which tracks inputs from users on a real-time basis, where the inputs may be resource data or user activity data. In some embodiments, the system may further include a data analytics engine that, based on both historical data and data provided by the users in real time, predicts future subsequent actions or inputs by the user based on the resource data provided by the user or actions taken by the user, and provide suggestions of potential resources or portal tools of interest to the user. Such historical data may be stored on a long-term basis in a user input database. For instance, in one embodiment of the invention, a user may upload a file including a sample of source code to the system. The system may detect that the file includes source code and, based on the contents of the source code therein, the system may make a number of recommendations to the user. The system may make this determination, for example, by reading the contents of the source code, such as the types of functions used, the programming language used, and the software libraries incorporated within the code. In response, the system may provide a listing of additional project opportunities that may be suitable to the user.

In some embodiments, the system may include an online portal which serves as the interface between the system and the users. The system may run its processes on a server or network of servers which users may access using a computing device. In some embodiments, the system may provide to the user a client application or program which is used to access the server-side application over a network. The online portal may present a graphical interface to the display of the user device, through which the user may select from a number of tools and functions provided by the system. For instance, the system may provide tools to predict resource data and temporal action triggers.

In some embodiments, rather than or in addition to providing suggestions, the data analytics engine may, based on tracking a user's inputs, the user's attributes, resource attributes, historical data, and the like, dynamically predict subsequent actions that the user intends to take within the client application, graphical interface or otherwise when interacting with the resource processing system. Thereafter, the system may transmit a command to a client application on the user's device that causes the application to display an interface for performing the predicted future action. For example, the system may have stored historical data which shows that a user requests access to a particular resource when the user logs onto the system in regular time intervals. Upon detecting that the user has logged on, that the calculated time period has passed, and the user has not yet requested the particular resource, the system may automatically prompt the user to access the particular resource. In this way, the system allows the user to bypass the manual extraneous steps to access the particular resource, thereby improving the computing efficiency of the servers on which the system is implemented.

In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users.

With the proliferation of Internet technology in recent times, people may utilize multiple online systems to access resources. Typically, the users may perform actions relating to resource transmissions and modifications associated with the various technology activity systems. However, conventional systems are unable to identify the disparate actions associated with the technology activity systems, much less analyze the specific parameters, and operatively connect and map interrelated actions. Accordingly, there is a need for a more efficient and dynamic way to determine the efficiency of multiple resources so that users can measure their efficiency and alter decisioning based on resource outlook.

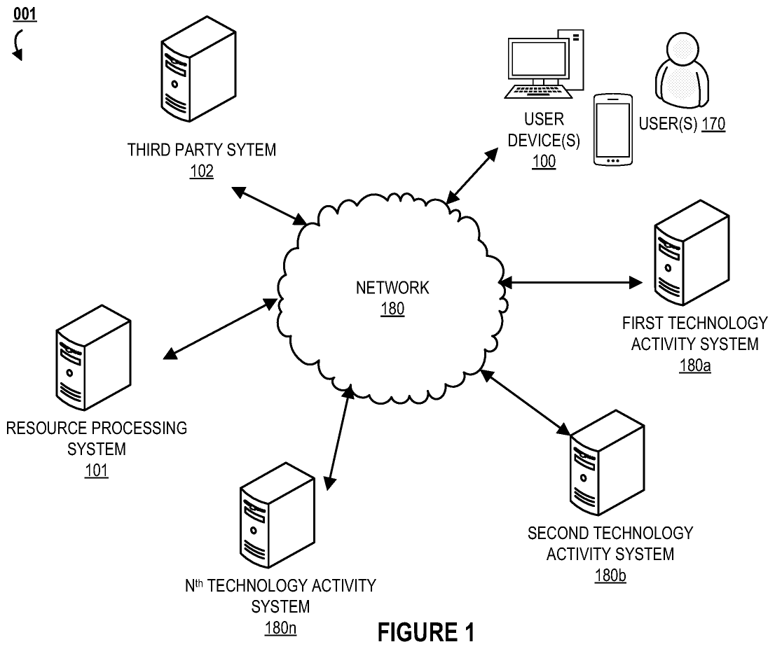

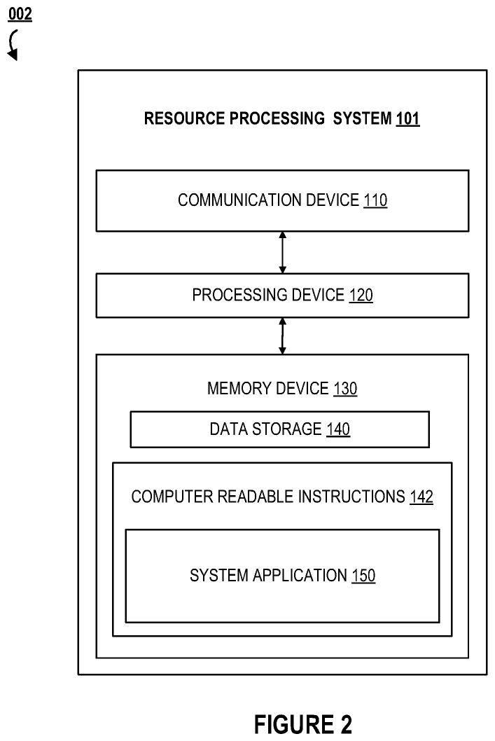

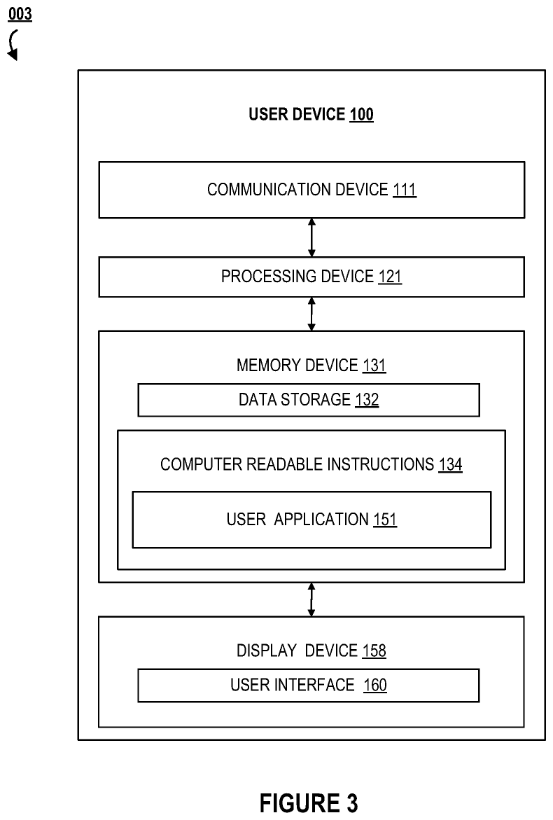

FIG. 1 is a block diagram illustrating an operating environment 001 structured for dynamic event-based integration of resources and temporal resource processing, in accordance with one embodiment of the present invention. The operating environment may include a resource processing system 101 in operative communication with a user device 100, one or more technology activity systems 180 (e.g., a first technology activity system 180a, a second technology activity system 180b, . . . , and/or a N^{th} technology activity system 180n), over a network 180. Technology activity systems include systems and/or applications directed to service type entities, such as gig type work or entities, examples of which include ride-sharing, delivery, writing services, cleaning, rentals, and/or the like. The network 180 may be a global area network (GAN), such as the Internet, a wide area network (WAN), a local area network (LAN), or any other type of network or combination of networks. The network 180 may provide for wireline, wireless, or a combination wireline and wireless communication between devices on the network 180. The user device 100 may be associated with a user 170. The user 170 may be an employee, a worker, a member or be otherwise associated with the one or more technology activity systems 180. The user device 100 comprise one or more of a mobile device such as a smartphone, tablet, or laptop, a personal computing device such as a desktop computer, smart device, single board computer, or a device owned and operated by an entity, such as a computer system terminal located on the entity's premises. The user device 100 will be described in detail later on with respect to FIG. 2. The resource processing system 101 is structured for executing a resource management application and performing its various processes, as will be described with respect to FIG. 3 later on. It should be understood that the resource processing system 101 as depicted herein may be embodied in a single server or multiple servers distributed over varying geographic distances.

Generally, the user device 100 is used to log onto the resource processing system 101 over the network 180 to access an online portal (e.g., over a secure communication channel). The resource processing system 101 may require that authentication credentials are provided by the user device 100. In some embodiments, the authentication credentials may include a username, password, a biometric identifier, a cryptographic key, a token, and the like. The resource processing system 101 may further require that more than one authentication credential is provided as parts of a multi-step authentication process. Once the user has been authenticated, the user may log onto the online portal on the resource processing system 101 using the user device 100 to access the resources and resource management tools therein.

In some embodiments, the operating environment may further include a third-party system 102 which may be in operative communication with the user device 100, the resource processing system 101, or both, over the network 180. The third-party server 102 may contain data associated with the user which may be accessed by some of the resource management tools run on the resource processing system 101. This configuration allows the resource processing system 101 to automatically pull the data associated with the user from the third-party server 102 in order to run its various processes. For example, the third-party server 102 may contain data relating to the user's financial accounts, and the resource processing system 101 may provide tools to manage that data. In such an embodiment, the user may provide a second set of authentication credentials associated with the user's financial account to the third-party server 102 directly. Alternatively, the user may store the second set of authentication credentials on the resource processing system 101, which may then use said authentication credentials to access the data within the third-party server 102.

FIG. 2 illustrates a schematic depiction 002 of the resource processing system 101 of FIG. 1, in accordance with one embodiment of the present invention. The resource processing system 101 typically contains a processing device 120 (also referred to as a processor 120) operatively coupled to a communication device 110 and a memory device 130. The processing device 120, and other processing devices/processors described herein, typically include circuitry for implementing communication and/or logic functions of the system 101. For example, the processing device 120 may include a digital signal processor device, a microprocessor device, and various analog to digital converters, digital to analog converters, and/or other support circuits.

The resource processing system 101 may use the communication device/interface 110 to communicate with other devices over the network 180. The communication device 110 as used herein may include an Ethernet interface, an antenna coupled to a transceiver configured to operate on a cellular data or Wi-Fi signal, and/or a near field communication (“NFC”) interface.

The resource processing system 101 may include a memory device 130 operatively coupled to the processing device 120. As used herein, memory includes any computer readable medium (as defined herein below) such as data storage 140 configured to store computer readable instructions 142, and other data, code, or other information. The memory device 130 may include volatile memory, such as volatile Random Access Memory (RAM) including a cache area for the temporary storage of data. The memory device 130 may also include non-volatile memory, which can be embedded and/or may be removable. The non-volatile memory can additionally or alternatively include an electrically erasable programmable read-only memory (EEPROM), flash memory or the like.

Typically, a system application 150 is stored within the memory device 130 to implement the functions of the online portal through the processing device 120 on the resource processing system 101. The system application 150 allows a user 170 to connect to the resource processing system 101 through a user device 100, in order to access the resource data therein as well as utilize the resource management tools provided through the online portal. The system 150 includes the logic code portions to determine the appropriate resource recommendations as well as the code portions to collect usage and historical data from the plurality of users 170 within the system.

The memory device 130 may further include a data storage 140 or a database 140 containing data to be processed and/or manipulated by the system application 150. The database 140 may contain usage and historical data provide by the users 170. The database 140 may also contain data on the various classifications to be used to categorize the resources and the users, on what classifications correspond to which resources, as well as logical links between and amongst the various resources and the users. It should be understood that while the database 140 is depicted as a single unit within a single resource processing system 101 in FIG. 2, the database 140 may represent multiple databases implemented across multiple resource processing systems 101. It should also be understood that the system application 150 may implemented in a distributed manner amongst a plurality resource processing systems 101. The database 140 may also be stored on a separate, distinct memory 130 from the system 150.

FIG. 3 illustrates a schematic depiction 003 of the user device 100 of FIG. 1, in accordance with one embodiment of the present invention. The user device 100 typically includes a processing device 121 (also referred to as a processor 121) operatively coupled to a communication device 111, a memory device 131, and a display device 158. The memory 131 typically stores a user application 151 such as a resource management application 151, which causes the processor 121 to display a user interface 160 to the user 170 on the display device 158. It should be understood that the display device 158 on which the user interface 160 is presented may include an integrated display (e.g. a tablet or smartphone screen) within the user device 100, or an external display device (e.g. a computer monitor or television). The resource management application 151 establishes a connection with the resource management server application 150 over the network 180 to allow the user 170 to access the various functions of the system. In particular, the resource management application 151 receives inputs from the user interface 160, which may include such inputs as user authentication credentials, requests to upload resource data, which may include various types of data such as activity data, to the resource processing system 101, requests to utilize the resource processing tools of the system application 150 (described in FIG. 2), and the like.

As used herein, the user interface 160 may be a graphical user interface that facilitates communication using one or more communication mediums such as tactile communication (such, as communication via a touch screen, keyboard, and the like), audio communication, textual communication and/or video communication (such as, gestures). Typically, a graphical user interface (GUI) of the present invention is a type of interface that allows users to interact with electronic elements/devices such as graphical icons and visual indicators such as secondary notation, as opposed to using only text via the command line. That said, the graphical user interfaces are typically configured for audio, visual and/or textual communication, and are configured to receive input and/or provide output using one or more user device components and/or external auxiliary/peripheral devices such as a display, a speaker, a microphone, a touch screen, a camera, a GPS device, a keypad, a mouse, and/or the like. In some embodiments, the graphical user interface may include both graphical elements and text elements. The graphical user interface is configured to be presented on one or more display devices associated with user devices, entity systems, auxiliary user devices, processing systems and the like.

In some embodiments, the user 170 accesses the resource management application 151 through the user interface 160. The resource management application 151 sends a request over the network 180 to establish a communication link with the resource processing system 101 through system application 150. Upon receiving the request, the system application 150 causes the resource processing system 101 to send a command to the user device 100 to prompt the user 170 for authentication credentials through the user interface 160. Upon receiving authentication credentials from the user 170, the resource management application 151 sends the authentication credentials to the system application 150. Upon successful authentication, a communication link between the resource management application 151 and the system application 150 is established. The user 170 then provides a request to upload resource data to the resource management application 151, which then sends the resource data to the system application 150. The system application 150 then processes the contents of the resource data, and based on a combination of user inputs, historical data within the database 140, and various types of data found within the resource data, adds classifications or tags to the user 170 and/or the resource data provided by the user. The system application 150 then predicts future actions that the user 170 intends to take within the user interface 160 and prompts the user through a notification to take the intended future action.

The system may store user activity data within the online portal within the database 140. In some embodiments, the system application 150 may cause the processor 120 to periodically query the user device 100 to obtain snapshots of the state of the resource management application 151. Upon receiving the query, the resource management application 151 may immediately obtain a snapshot of user actions taken within the graphical interface, then send the snapshot to the resource processing system 101. In other embodiments, the resource management application 151 may continuously track user inputs and temporarily store them in the memory 131, then send the history of user inputs to the resource processing system 101 upon receiving the query. In other embodiments, the resource management application 151 may periodically track the user's inputs and push the input data to the resource processing system 101 without waiting to receive a query.

In some embodiments, the system may dynamically track usage data through the resource management application on the user device. In particular, the resource management application may track user inputs, such as mouse cursor positions, touchscreen inputs, keystrokes, and the like. The system may establish a secure communication channel with the resource management application or other client application on the user device in order to obtain real-time usage data of the user's actions within the application. Based on these user inputs as well as historical data and the user's attributes/classification(s) (and attributes/classification(s) of resources of the user), the system may predict future actions that the user intends to take (e.g., within a client application) and make recommendations according to the predictions.

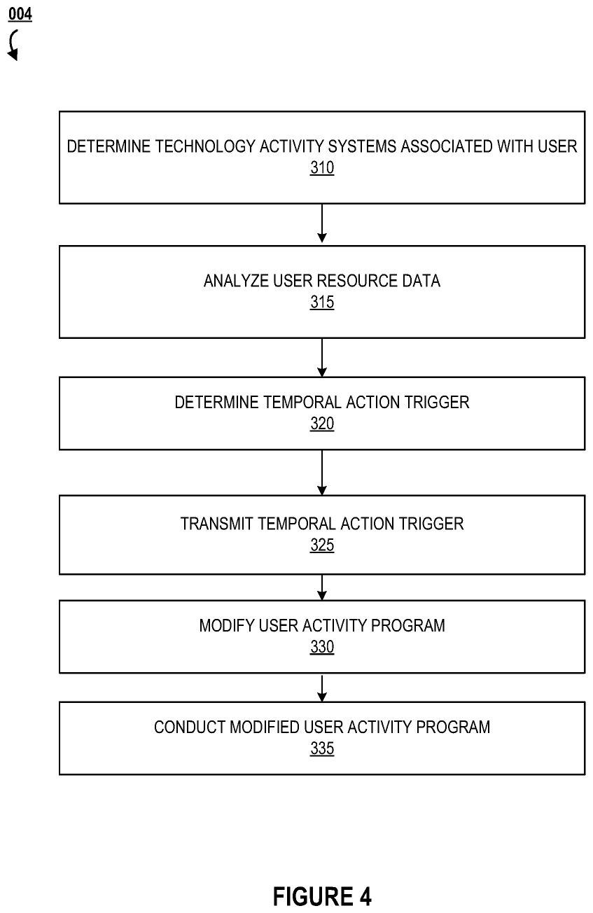

Now referring to FIG. 4 illustrating a high level process flow 004 for dynamic event-based integration of resources and temporal resource processing. This high level process flow 004 may be performed by the system 101 described herein (e.g., by the resource processing system 101), either singularly or in conjunction with other devices/systems of the network 180. The system is structured for dynamic integration of resources and resource processing based on events.

Typically, the user is associated with one or more technology activity systems. As discussed previously, the one or more technology activity systems (e.g., a first technology activity system, a second technology activity system, . . . , and/or a N^{th} technology activity system), may comprise systems, devices, and/or applications directed to service type entities, such as gig type work or entities, examples of which include ride-sharing, delivery, writing services, cleaning, rentals, and/or the like, and may comprise systems, devices, and/or applications directed to providing products and services for the foregoing. Here, the user may perform or may be associated with one or more user activities with each of the one or more technology activity systems. As a non-limiting example, the user may be associated with a first user activity (of the one or more user activities) of driving for a first entity associated with a first technology activity system, the user may be associated with a second user activity (of the one or more user activities) of providing rental dwellings for a second entity associated with a second technology activity system, the user may be associated with a third user activity (of the one or more user activities) of delivering items for a third entity associated with a third technology activity system, the user may be associated with a fourth user activity (of the one or more user activities) of purchasing vehicle repairs/maintenance from a fourth entity associated with a fourth technology activity system, and/or the like. Typically, one or more resources of the user are connected to at least one of the one or more technology activity systems such that the one or more user activities associated with the one or more technology activity systems activates a modification (increase or decrease) to a resource level of at least one of the one or more resources. Moreover, the user may perform or may be associated with one or more user activities with the one or more technology activity systems that result in incoming resource transfers (e.g., inflow wages, etc.) to resources of the user producing an increase in a respective resource level, and/or one or more user activities with the one or more technology activity systems that result in outgoing resource transfers (e.g., payments, purchases, etc.) from resources of the user that produce a decrease in a respective resource level.

As such, the user may be in operative communication with numerous disparate technology activity systems. As discussed, the users may perform user activities relating to resource transmissions and modifications associated with the various technology activity systems. Here, conventional systems are unable to identify the disparate actions associated with the technology activity systems, much less analyze the specific parameters, and operatively connect and map interrelated activities. Accordingly, because of the inherent disparate nature of the technology activity systems, the user is not able to determine overall incoming resource transfers and outgoing resource transfers across the various technology activity systems, much less dynamically and in real-time determine whether the user comprises a positive net escalation of the resource level (e.g., profit) for the one or more user activities. Moreover, the inherent disparate, temporal, and dynamically variable nature of the user actions and associated resource transmissions and modifications associated with the various technology activity systems, causes inefficiencies of computing resources such as processing power, memory, and network bandwidth in conventional systems. The present system solves the foregoing problems in conventional system and provides additional advantages as described below.

Initially, the system may establish an operative communication channel with a user device associated with a user. At block 310, the system may determine technology activity systems associated with the user. In this regard, in some embodiments, the system may analyze one or more applications on the user device, and determine the one of more technology activity systems based on analyzing the one or more applications. Moreover, the system may extract user resource data (e.g., activity data, historical resource transmissions, associated entities, associated technology activity systems, and/or the like) associated with one or more resources of the user. The system may analyze the user resource data to determine the one or more user activities that the user performs (or is associated with) with each of the one or more technology activity systems. In some embodiments, the system may determine the user activity(s) and the respective technology activity system(s) based on identifying the modifications (increase or decrease) to a resource level of one or more resources activated by or caused by the user activity.

In some embodiments, the system may perform dynamic and real-time integration and aggregation of the temporal user activities and the respective modifications (increase or decrease) to resource levels of one or more resources, across the various disparate technology activity systems. Here, the system may first analyze user resource data associated with the one or more resources of the user. Next, the system may determine, for each of the one or more resources, the one or more technology activity systems that are associated with modifications to the associated resource level. Subsequently, the system may aggregate the user activity data and the user resource data across the one or more technology activity systems. Here, the system may determine, in real-time, for each of the one or more technology activity systems, incoming resource transfers, outgoing resource transfers, and net escalation of the resource level for the one or more user activities (e.g., profit). The system may construct an integrated interface associated with aggregation of the temporal user activities and the respective modifications (increase or decrease) to resource levels of one or more resources, across the various disparate technology activity systems. The system may then initiate, via the operative communication channel with the user device, a presentation of an integrated interface comprising the aggregated user activity data and user resource data in real-time on a display device of the user device.

In some embodiments, the system aggregates external data from outside data sources associated with a user from other applications within the user device. Outside data may include data such as geographical location, weather, events, user device IOT, and data associated with the technology activity systems. In some embodiments, this is accomplished using an application programing interface. In another embodiment, the system may collect data from user input. In some embodiments, the data collected at block 310 is used to predict impact of said data on the future resource level of the user and present temporal action triggers to the user to facilitate an increase in future resource level.

Next, at block 315, the system may analyze user activity data associated with the one or more technology systems to construct a user activity program associated with the user. Typically, the user activity program comprises one or more user program actions of the one or more user activities, with each of the one or more user program actions being associated with one or more action attributes. Typically, the user activity program is directed to current and/or future actions/activities associated with the one or more technology activity systems. In some embodiments, the one or more user program actions are a subset of the one or more user activities. Moreover, the each of the user program actions may be associated with action attributes such as the respective technology activity system, a time interval associated with the action, an associated geographic location, associated resource, an estimated modification (increase or decrease) in resource level, and/or the like. As a non-limiting example, the system may construct a user activity program comprising user program actions within an upcoming time interval in a week between day 1 to day 6. Here, the system may determine that the user is associated with performing a first user program action (of the one or more user program actions) of driving for a first entity associated with a first technology activity system on day 2, and performing a second user program action (of the one or more user program actions) of driving for a second entity associated with a second technology activity system on day 3.

In some embodiments, the system may allow the user to determine whether a particular program action would result in a predetermined increase in a resource level (e.g., profit) before deciding whether or not to undertake the particular program action. Here, the system may receive, via the operative communication channel with the user device, a first program action (e.g., driving for a predetermined time interval on a certain day at a certain location with a particular technology activity system) of the one or more program actions from the user. Here, the system may analyze the aggregated user activity data and user resource data, and connect and map interrelated actions across the various technology activity systems, determine any interconnected action that may result in a decrease in a resource level (e.g., an outgoing resource transfer for purchase of fuel likely required for driving for the predetermined time interval). Based on the aggregated user activity data and user resource data, the system may determine an estimated first net escalation (e.g., positive net escalation or profit, negative net escalation or loss, and/or the like) of the resource level for the first program action. Subsequently, the system may initiate, via the operative communication channel with the user device, a presentation of the first net escalation of the resource level on the display device of the user device, so that the user can determine whether or not to undertake the particular program action.

In some embodiments, the system will analyze user resource data, at block 315 to predict the impact of potential temporal action triggers on the resource level of the user and determine a temporal action trigger which maximizes the user resource level at block 320. As indicated by block 320, the system may construct/determine, a temporal action trigger associated with the user activity program. Typically, the temporal action trigger is associated with (i) a time attribute, (ii) a geographical local attribute, and (iii) an event attribute that matches the user activity program, such that the temporal action trigger is structured to cause an escalation of a resource level (e.g., positive net escalation or profit) of at least one of the one or more resources.

In some embodiments, the temporal action trigger is constructed based on extracting geographic location data from the user device, and subsequently determining the geographic parameters associated with the user activities/actions (e.g., the geographic regions associated with the user activities/actions) and time intervals when the user activities/actions were conducted. The system may then construct the time attribute and the geographical local attribute associated with the temporal action trigger based on at least the geographic location data associated with the user device.

In some embodiments, the temporal action trigger is constructed for dynamic integration of resources and resource processing based on events. Here, the system may determine a user geographic region associated with the user based on analyzing geographic location data associated with the user, as discussed above. The system may the determine one or more events that match the user geographic region. Typically, the events are not already factored into the user activity program. The system may then identify a first event of the one or more events such that (i) the first event matches the user activity program and (ii) modifying the user activity program to include the first event is structured to cause the escalation of the resource level of the at least one of the one or more resources. Subsequently, the system may construct the event attribute associated with the temporal action trigger based on the first event.

Continuing with the previous non-limiting example, the system may construct a user activity program comprising user program actions within an upcoming time interval in a week between day 1 to day 6. Here, the system may determine that the user is associated with performing a first user program action (of the one or more user program actions) of driving for a first entity associated with a first technology activity system on day 2 at a city location region 1, and performing a second user program action (of the one or more user program actions) of driving for a second entity associated with a second technology activity system on day 3 at a city location region 2. The system may the system may the determine one or more events that match the user geographic region (e.g., city location region 1 and city location region 2). Here, the system may determine a first event of the one or more events directed to a crowd-based event such as a concert, a sports match/game, a fair, and/or another event that likely requires an increased number of ride-share users at a specific geographical location during the time of the event. The system may determine that the first event is scheduled for day 3 at a venue of city location region 3 within a predetermined proximity of the city location region 2, and subsequently determine that the first event matches the user geographic region and the user activity program. The system may further determine that the user driving at the venue of the first event would produce a larger escalation of the resource level (e.g., inflow or profit) than the prior second user program action (of the one or more user program actions) of driving for a second entity associated with a second technology activity system on day 3 at a city location region 2. Subsequently, the system may construct the temporal action trigger to replace the second user program action with a new program action of directing the user to the venue of the first event of day 3.

Continuing with the previous non-limiting example, the system may construct a user activity program comprising user program actions within an upcoming time interval in a week between day 1 to day 6. Here, the system may determine that the user is associated with performing a first user program action (of the one or more user program actions) of driving for a first entity associated with a first technology activity system on day 2 at a city location region 1, and performing a second user program action (of the one or more user program actions) of driving for a second entity associated with a second technology activity system on day 3 at a city location region 2. The system may the system may the determine one or more events that match the user geographic region (e.g., city location region 1 and city location region 2). Here, the system may determine a second event of the one or more events directed to an offer or a rebate (e.g., a ride challenge) provided by a technology activity system. The system may determine the second event of a ride challenge provided by a fifth technology activity system directed to doubling the resource escalation level (e.g., inflow or profit) if the user drives during a predetermined time interval on day 5 at the city location region 1. The system may determine that the user is not scheduled for other conflicting activities during the predetermined time interval on day 5, and subsequently determine that the first event matches the user activity program. The system may further determine that the user driving during the predetermined time interval on day 5 with the second event of a ride challenge, would produce a larger escalation of the resource level (e.g., inflow or profit) than the prior first user program action (of the one or more user program actions) of driving for a first entity associated with a first technology activity system on day 2 at a city location region 1. Subsequently, the system may construct the temporal action trigger to replace the first user program action with a new program action of directing the user to drive during the predetermined time interval on day 5 with the second event of a ride challenge instead.

In some embodiments, the temporal action trigger is constructed for dynamic smoothing of resource transfers. Here, the temporal action trigger is structured to modify a time associated with at least one of the incoming resource transfers and the outgoing resource transfers. In other words, the temporal action trigger may be structured to modify the timing of the program actions in order to provide a smoother inflow and outflow resource pattern for the user's resources.

In some embodiments, the system may determine multiple temporal action triggers and determine the optimal temporal action trigger for implementations. Alternatively, the system may implement multiple temporal actions for a particular user activity program.

As discussed previously, in some embodiments, the system may allow the user to determine whether a particular program action would result in a predetermined increase in a resource level (e.g., profit) before deciding whether or not to undertake the particular program action. Here, the system may receive, via the operative communication channel with the user device, a first program action (e.g., driving for a predetermined time interval on a certain day at a certain location with a particular technology activity system) of the one or more program actions from the user. Based on the aggregated user activity data and user resource data, the system may determine an estimated first net escalation (e.g., positive net escalation or profit, negative net escalation or loss, and/or the like) of the resource level for the first program action. In response to determining that the estimated first net escalation is below a predetermined threshold, the system may construct the temporal action trigger to modify the first program action. Here, the system may determine a temporal action trigger associated with the user activity program such that the temporal action trigger causes the escalation of the resource level of at least one of the one or more resources by (i) causing a second net escalation of the resource level that is greater than the first net escalation, or (ii) converting a negative first net escalation of the resource level to a positive net escalation of the resource level for the first program action.

As indicted by block 325, the system may then transmit, via the operative communication channel, the temporal action trigger to the user device. Here, the system may initiate, via a display device of the user device, a presentation of the temporal action trigger on via an integrated interface of a user device application. Typically, the presentation of the temporal action trigger comprises a presentation of the estimated escalation of the resource level of the at least one of the one or more resources and prior resource level in absence of the temporal action trigger, indicating the enhanced resource level obtainable by implementing the temporal action trigger. The system may subsequently receive a predetermined input from the user (e.g., authorization to implement the temporal action trigger) via the integrated interface of the user device application. The system may then modify, in real time, the user activity program based on the temporal action trigger in response to receiving a predetermined input from the user at the user device, as indicated by block 330. Subsequently, as indicated by block 335, the system may conduct, via the user device, the modified user activity program.

In some embodiments, the transmission of the user activity program to the user device at block 325 is accomplished via an application with an integrated interface for the user's viewing and manipulation of the data on the user device. In an example, an increased resource level may be predicted from a specific geographical location at a specific time. In the ride-share example, this increased resource level may be related to a heavily attended event, requiring an increased number of ride-share users at a specific geographical location during the time of the event.

In some embodiments, the modification of the user activity program at block 330, includes a temporal action trigger that is implemented in real-time with a predetermined time-interval. In the ride-share example, the user activity program may present temporal action triggers for the user to complete a specified number of ride-shares in a specified period of time for a one-time resource bonus.

In some embodiments, the system is configured to present temporal action triggers to the user via an application within an integrated interface. The system may run its processes on a server or network of servers which users may access using a computing device. In some embodiments, the system may provide to the user a client application or program which is used to access the server-side application over a network. The online portal may present an integrated interface to the display of the user device, through which the user may select from a number of tools and functions provided by the system.

The integrated interface may include a number of panels which may receive inputs or display information to the user. For example, the integrated interface may include a resource input panel, which allows the user to upload resource data into the system. The resource input panel may contain buttons or areas that receive user input related to the resources, such as a text entry box, or a sub-panel through which the user may upload various media files to the system.

The integrated interface may also include a notifications panel, through which the system provides resource recommendations to the user. The user may select the notification to access predicted data, recommendations, and information related to temporal action triggers. In some embodiments, the user may manipulate inputs within the graphical interface for further predicted data and temporal action triggers.

In some embodiments, the system may generate a user activity program for the user. The user activity program may determine a temporal action trigger for the user associated with a geographical location attribute, a time attribute, and an event attribute. The user activity program may structure the temporal action trigger to cause an escalation or optimization of a resource level of the user.

In some embodiments, the system may implement temporal action triggers in real-time with a predetermined time-interval. For example, the temporal action trigger is specific to a time and activity. In some embodiments, the temporal action trigger is unique to a user. In some embodiments, the temporal action triggers are initiated by a third party. In some embodiments the temporal action trigger is associated with an increased resource level. As an example, the entity may offer resource related motivation to completing various activities within a specified time or geographical location. In the ride-share example, the entity may offer increased resources for sharing a specific number of rides during a specified time interval.

In some embodiments, the system receives input from the user through the user interface. This input may be information related to a resource goal. The system may use this information, along with predicted information

Each communication interface described herein generally includes hardware, and, in some instances, software, that enables the computer system, to transport, send, receive, and/or otherwise communicate information to and/or from the communication interface of one or more other systems on the network. For example, the communication interface of the user input system may include a wireless transceiver, modem, server, electrical connection, and/or other electronic device that operatively connects the user input system to another system. The wireless transceiver may include a radio circuit to enable wireless transmission and reception of information.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for dynamic event-based integration of resources and temporal resource processing, wherein the system is structured for dynamic integration of resources and resource processing based on events, the system comprising:
at least one memory device with computer-readable program code stored thereon;
at least one communication device; and
at least one processing device operatively coupled to the at least one memory device and the at least one communication device, wherein executing the computer-readable program code is configured to cause the at least one processing device to:
establish an operative communication channel with a user device associated with a user;
determine, via the operative communication channel with the user device, one or more technology activity systems associated with the user, wherein the user is associated with one or more user activities with each of the one or more technology activity systems;
extract user resource data associated with one or more resources of the user, wherein each of the one or more resources are connected to at least one of the one or more technology activity systems such that the one or more user activities associated with the one or more technology activity systems activates a modification to a resource level of at least one of the one or more resources;
analyze user activity data associated with the one or more technology systems to construct a user activity program associated with the user, wherein constructing the user activity program comprises one or more user program actions of the one or more user activities, wherein each of the one or more user program actions is associated with one or more action attributes;
determine, via the one or more technology systems, a temporal action trigger associated with the user activity program, wherein the temporal action trigger is associated with (i) a time attribute, (ii) a geographical local attribute, and (iii) an event attribute that matches the user activity program, wherein the temporal action trigger is structured to cause an escalation of a resource level of at least one of the one or more resources;
transmit, via the operative communication channel, the temporal action trigger to the user device;
modify, in real time, the user activity program based on the temporal action trigger in response to receiving a predetermined input from the user at the user device; and
conduct, via the user device, the modified user activity program.

2. The system of claim 1, wherein executing the computer-readable program code is further configured to cause the at least one processing device to:
analyze one or more applications on the user device; and
determine the one of more technology activity systems based on analyzing the one or more applications.

3. The system of claim 1, wherein determining the temporal action trigger associated with the user activity program further comprises:
extracting geographic location data from the user device; and
constructing the time attribute and the geographical local attribute associated with the temporal action trigger based on at least the geographic location data associated with the user device.

4. The system of claim 1, wherein determining the temporal action trigger associated with the user activity program further comprises:
determining a user geographic region associated with the user based on analyzing geographic location data associated with the user;
determining one or more events that match the user geographic region, wherein the user activity program is not associated with the one or more events;
identifying a first event of the one or more events such that (i) the first event matches the user activity program and (ii) modifying the user activity program to include the first event is structured to cause the escalation of the resource level of the at least one of the one or more resources; and
constructing the event attribute associated with the temporal action trigger based on the first event.

5. The system of claim 1, wherein executing the computer-readable program code is further configured to cause the at least one processing device to:
analyze user resource data associated with the one or more resources of the user;
determine, for each of the one or more resources, the one or more technology activity systems that are associated with modifications to the associated resource level;
aggregate the user activity data and the user resource data across the one or more technology activity systems, comprising determining, in real-time, for each of the one or more technology activity systems, incoming resource transfers, outgoing resource transfers, and net escalation of the resource level for the one or more user activities; and
initiate, via the operative communication channel with the user device, a presentation of an integrated interface comprising the aggregated user activity data and user resource data in real-time on a display device of the user device.

6. The system of claim 5, wherein executing the computer-readable program code is further configured to cause the at least one processing device to:
receive, via the operative communication channel with the user device, a first program action of the one or more program actions from the user;
based on the aggregated user activity data and user resource data, determine a first net escalation of the resource level for the first program action; and
initiate, via the operative communication channel with the user device, a presentation of the first net escalation of the resource level on the display device of the user device.

7. The system of claim 6, wherein the temporal action trigger is structured to modify the first program action, wherein executing the computer-readable program code is further configured to cause the at least one processing device to: determine the temporal action trigger associated with the user activity program such that the temporal action trigger causes the escalation of the resource level of at least one of the one or more resources by (i) causing a second net escalation of the resource level that is greater than the first net escalation, or (ii) converting a negative first net escalation of the resource level to a positive net escalation of the resource level for the first program action.

8. The system of claim 5, wherein the temporal action trigger is structured to modify a time associated with at least one of the incoming resource transfers and the outgoing resource transfers.

9. The system of claim 1, wherein transmitting the temporal action trigger to the user device further comprises:
initiating, via a display device of the user device, a presentation of the temporal action trigger on via an integrated interface of a user device application, wherein the presentation of the temporal action trigger comprises a presentation of the escalation of the resource level of the at least one of the one or more resources and prior resource level in absence of the temporal action trigger; and
receiving the predetermined input from the user via the integrated interface of the user device application.

10. A computer program product for dynamic event-based integration of resources and temporal resource processing, whereby the computer program product is structured for dynamic integration of resources and resource processing based on events, the computer program product comprising a non-transitory computer-readable storage medium having computer executable instructions to:
establish an operative communication channel with a user device associated with a user;
determine, via the operative communication channel with the user device, one or more technology activity systems associated with the user, wherein the user is associated with one or more user activities with each of the one or more technology activity systems;
extract user resource data associated with one or more resources of the user, wherein each of the one or more resources are connected to at least one of the one or more technology activity systems such that the one or more user activities associated with the one or more technology activity systems activates a modification to a resource level of at least one of the one or more resources;
analyze user activity data associated with the one or more technology systems to construct a user activity program associated with the user, wherein constructing the user activity program comprises one or more user program actions of the one or more user activities, wherein each of the one or more user program actions is associated with one or more action attributes;
determine, via the one or more technology systems, a temporal action trigger associated with the user activity program, wherein the temporal action trigger is associated with (i) a time attribute, (ii) a geographical local attribute, and (iii) an event attribute that matches the user activity program, wherein the temporal action trigger is structured to cause an escalation of a resource level of at least one of the one or more resources;
transmit, via the operative communication channel, the temporal action trigger to the user device;
modify, in real time, the user activity program based on the temporal action trigger in response to receiving a predetermined input from the user at the user device; and
conduct, via the user device, the modified user activity program.

11. The computer program product of claim 10, wherein the non-transitory computer-readable storage medium further comprises computer executable instructions to:
analyze one or more applications on the user device; and
determine the one of more technology activity systems based on analyzing the one or more applications.

12. The computer program product of claim 10, wherein determining the temporal action trigger associated with the user activity program further comprises:
extracting geographic location data from the user device; and
constructing the time attribute and the geographical local attribute associated with the temporal action trigger based on at least the geographic location data associated with the user device.

13. The computer program of claim 10, wherein determining the temporal action trigger associated with the user activity program further comprises:
determining a user geographic region associated with the user based on analyzing geographic location data associated with the user;
determining one or more events that match the user geographic region, wherein the user activity program is not associated with the one or more events;
identifying a first event of the one or more events such that (i) the first event matches the user activity program and (ii) modifying the user activity program to include the first event is structured to cause the escalation of the resource level of the at least one of the one or more resources; and
constructing the event attribute associated with the temporal action trigger based on the first event.

14. The computer program of claim 10, wherein the non-transitory computer-readable storage medium further comprises computer executable instructions to:
analyze user resource data associated with the one or more resources of the user;
determine, for each of the one or more resources, the one or more technology activity systems that are associated with modifications to the associated resource level;
aggregate the user activity data and the user resource data across the one or more technology activity systems, comprising determining, in real-time, for each of the one or more technology activity systems, incoming resource transfers, outgoing resource transfers, and net escalation of the resource level for the one or more user activities; and
initiate, via the operative communication channel with the user device, a presentation of an integrated interface comprising the aggregated user activity data and user resource data in real-time on a display device of the user device.

15. The computer program of claim 10, wherein transmitting the temporal action trigger to the user device further comprises:
initiating, via a display device of the user device, a presentation of the temporal action trigger on via an integrated interface of a user device application, wherein the presentation of the temporal action trigger comprises a presentation of the escalation of the resource level of the at least one of the one or more resources and prior resource level in absence of the temporal action trigger; and
receiving the predetermined input from the user via the integrated interface of the user device application.

16. A method for dynamic event-based integration of resources and temporal resource processing, whereby the method is structured for dynamic integration of resources and resource processing based on events, the computer program product comprising a non-transitory computer-readable storage medium having computer executable instructions for:
establishing an operative communication channel with a user device associated with a user;
determining, via the operative communication channel with the user device, one or more technology activity systems associated with the user, wherein the user is associated with one or more user activities with each of the one or more technology activity systems;
extracting user resource data associated with one or more resources of the user, wherein each of the one or more resources are connected to at least one of the one or more technology activity systems such that the one or more user activities associated with the one or more technology activity systems activates a modification to a resource level of at least one of the one or more resources;
analyzing user activity data associated with the one or more technology systems to construct a user activity program associated with the user, wherein constructing the user activity program comprises one or more user program actions of the one or more user activities, wherein each of the one or more user program actions is associated with one or more action attributes;
determining, via the one or more technology systems, a temporal action trigger associated with the user activity program, wherein the temporal action trigger is associated with (i) a time attribute, (ii) a geographical local attribute, and (iii) an event attribute that matches the user activity program, wherein the temporal action trigger is structured to cause an escalation of a resource level of at least one of the one or more resources;
transmitting, via the operative communication channel, the temporal action trigger to the user device;
modifying, in real time, the user activity program based on the temporal action trigger in response to receiving a predetermined input from the user at the user device; and
conducting, via the user device, the modified user activity program.

17. The method of claim 16, wherein method further comprises:
analyzing one or more applications on the user device; and
determining the one of more technology activity systems based on analyzing the one or more applications.

18. The method of claim 16, wherein determining the temporal action trigger associated with the user activity program further comprises:
extracting geographic location data from the user device; and
constructing the time attribute and the geographical local attribute associated with the temporal action trigger based on at least the geographic location data associated with the user device.

19. The method of claim 16, wherein determining the temporal action trigger associated with the user activity program further comprises:
determining a user geographic region associated with the user based on analyzing geographic location data associated with the user;
determining one or more events that match the user geographic region, wherein the user activity program is not associated with the one or more events;
identifying a first event of the one or more events such that (i) the first event matches the user activity program and (ii) modifying the user activity program to include the first event is structured to cause the escalation of the resource level of the at least one of the one or more resources; and
constructing the event attribute associated with the temporal action trigger based on the first event.

20. The method of claim 16, wherein transmitting the temporal action trigger to the user device further comprises:
initiating, via a display device of the user device, a presentation of the temporal action trigger on via an integrated interface of a user device application, wherein the presentation of the temporal action trigger comprises a presentation of the escalation of the resource level of the at least one of the one or more resources and prior resource level in absence of the temporal action trigger; and
receiving the predetermined input from the user via the integrated interface of the user device application.
